(19) United States
(12) Patent Application Publication
(10) Pub. No.: US 2023/0184949 A1
(43) Pub. Date: Jun. 15, 2023

(54) LEARNING-BASED SYSTEM AND METHOD FOR ESTIMATING SEMANTIC MAPS FROM 2D LIDAR SCANS

(71) Applicant: Robert Bosch GmbH, Stuttgart (DE)

(72) Inventors: Xinyu Huang, San Jose, CA (US); Sharath Gopal, Fremont, CA (US); Lincan Zou, San Jose, CA (US); Yuliang Guo, Palo Alto, CA (US); Liu Ren, Saratoga, CA (US)

(21) Appl. No.: 17/546,102

(22) Filed: Dec. 9, 2021

(51) Int. Cl. G01S 17/89; G06V 20/70; G06V 10/774; G06V 10/40; G06V 10/98; G01S 7/48; G06N 20/00

(52) U.S. Cl. CPC G01S 17/89; G06V 20/70; G06V 10/774; G06V 10/40; G06V 10/993; G01S 7/4808; G06N 20/00

(57) ABSTRACT

A system and method are disclosed herein for developing robust semantic mapping models for estimating semantic maps from LiDAR scans. In particular, the system and method enable the generation of realistic simulated LiDAR scans based on two-dimensional (2D) floorplans, for the purpose of providing a much larger set of training data that can be used to train robust semantic mapping models. These simulated LiDAR scans, as well as real LiDAR scans, are annotated using automated and manual processes with a rich set of semantic labels. Based on the annotated LiDAR scans, one or more semantic mapping models can be trained to estimate the semantic map for new LiDAR scans. The trained semantic mapping model can be deployed in robot vacuum cleaners, as well as similar devices that must interpret LiDAR scans of an environment to perform a task.

### FIELD

The system and method disclosed in this document relates to processing sensor data and, more particularly, to estimating semantic maps from 2D LiDAR scans.

### BACKGROUND

Unless otherwise indicated herein, the materials described in this section are not admitted to be the prior art by inclusion in this section.

The light detection and ranging (LiDAR) sensors are commonly used by robot vacuum cleaners to obtain LiDAR scans of environment that is to be cleaned by the robot vacuum cleaner. However, these LiDAR scans tend to be noisy and incomplete. Accordingly, processes for interpreting these LiDAR scans tend to be highly prone to errors, which adversely affect the operations of the robot vacuum cleaner. Moreover, learning-based models for interpreting these LiDAR scans are challenging to develop due to the unavailability of and the expense of collecting sufficiently large sets of training data having the detailed annotations that would enable a learning-based model to provide robust and useful interpretation of new LiDAR scans.

### SUMMARY

A method for training a model to estimate semantic labels for LiDAR scans is disclosed. The method comprises receiving, with a processor, a floorplan. The method further comprises generating, with the processor, a simulated LiDAR scan by converting the floorplan using a physics-based simulation model. The method further comprises annotating, with the processor, the simulated LiDAR scan with semantic labels. The method further comprises training, with the processor, the model using the simulated LiDAR scan.

A method for operating a device is disclosed. The method comprises capturing, with a LiDAR sensor of the device, a LiDAR scan of an environment. The method further comprises generating, with a processor of the device, semantic labels for the LiDAR scan using a trained model, the model having been trained in-part using simulated LiDAR scans. The generating semantic labels comprises identifying portions of the LiDAR scan that correspond to a floor in the environment. The generating semantic labels further comprises identifying portions of the LiDAR scan that correspond to a wall in the environment. The method further comprises operating at least one actuator of the device to perform a task depending on the semantic labels for the LiDAR scan

### BRIEF DESCRIPTION OF THE DRAWINGS

The foregoing aspects and other features of the methods and systems are explained in the following description, taken in connection with the accompanying drawings.

FIG. 1A shows an exemplary LiDAR scan of a floorplan of a residential home.

FIG. 1B shows an exemplary semantic map generated based on the exemplary LiDAR scan of FIG. 1A.

FIG. 2 shows an exemplary embodiment of a computing device that can be used to develop and train a semantic mapping model.

FIG. 3 shows a method for developing a semantic mapping model that generates a richly annotated semantic map based on an input LiDAR scan.

FIG. 4 shows an exemplary 2D floorplan.

FIG. 5 shows an exemplary method for generating a simulated LiDAR scan based on a floorplan.

FIG. 6 shows an exemplary method for placing virtual objects into the virtual environment.

FIG. 7 shows an exemplary method for annotating simulated LiDAR scans and real LiDAR scans with semantic labels.

FIG. 8 shows an exemplary domain adaptation approach for training the semantic mapping model.

FIG. 9 shows an exemplary end-user device in the form of a robot vacuum cleaner that incorporates the trained semantic mapping model.

FIG. 10 shows a method for operating the robot vacuum cleaner using the trained semantic mapping model.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art which this disclosure pertains.

### OVERVIEW

A system and method are disclosed herein for developing robust semantic mapping models for estimating semantic maps from LiDAR scans. In particular, the system and method enable the generation of realistic simulated LiDAR scans based on two-dimensional (2D) floorplans, for the purpose of providing a much larger set of training data that can be used to train robust semantic mapping models. These simulated LiDAR scans, as well as real LiDAR scans, are annotated using automated and manual processes with a rich set of semantic labels. Based on the annotated LiDAR scans, one or more semantic mapping models can be trained to estimate the semantic map for new LiDAR scans. The trained semantic mapping model(s) can be deployed in robot vacuum cleaners, as well as similar devices that must interpret LiDAR scans of an environment to perform a task.

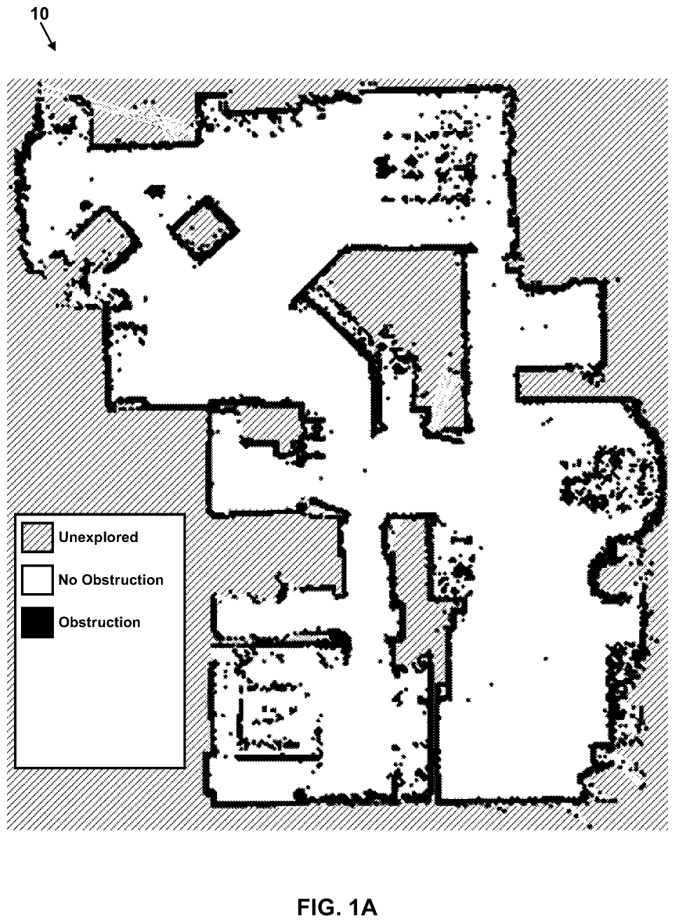

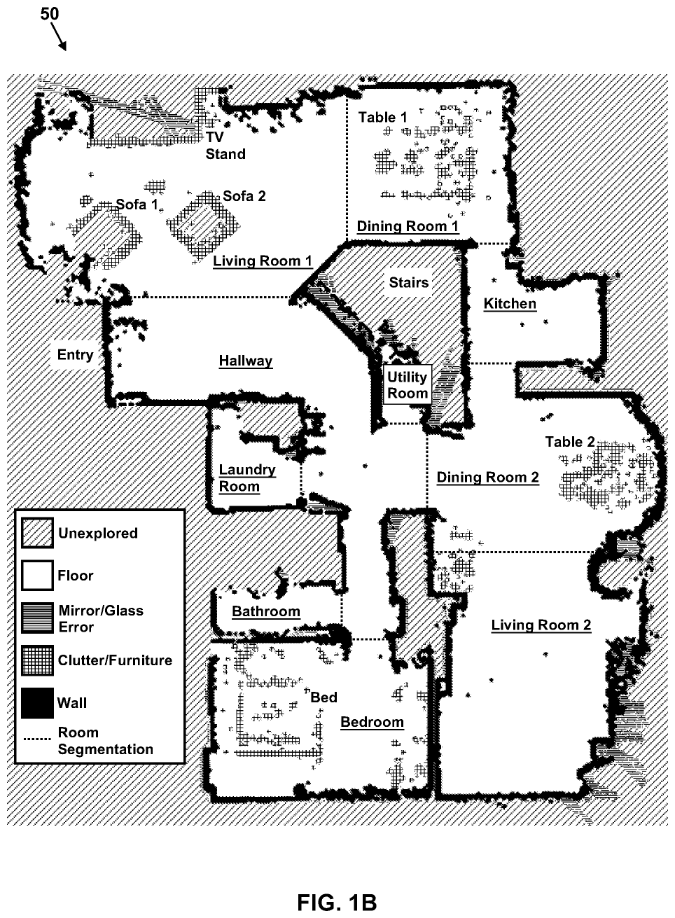

FIG. 1A shows an exemplary LiDAR scan 10 of a floorplan of a residential home. However, it should be appreciated that the systems and methods described herein can be applied to scans of environments other than a floorplan of a residential home. In its raw form, the exemplary LiDAR scan 10 takes the form of a point cloud, in which each individual point indicates a position in the floorplan at which a light emitted from a LiDAR sensor (e.g., a laser) was reflected back to the LiDAR sensor during a scanning process. Accordingly, each individual point (shown in solid black) indicates an estimated position of a physical obstruction in the floorplan that was scanned by the LiDAR sensor. Generally, during the scanning process, the LiDAR sensor is moved throughout the floorplan along a trajectory while continuously measuring times of flight and/or return times of the light emitted from the LiDAR sensor to generate the point cloud, in a known manner.

This point cloud is interpreted to further indicate positions in floorplan at which there was no reflective obstruction (shown in solid white) and positions in floorplan that were not explored during the scanning process (shown with diagonal hatching). The positions in the floorplan interpreted to include no reflective obstruction are those positions through which the measurement light traveled to reach the detected obstructions (i.e., in between the detected obstructions and the LiDAR sensor trajectory). Conversely, positions in the floorplan interpreted to be unexplored are those positions through which the measurement light did not travel during the scanning process.

It should be appreciated that the point cloud of the LiDAR scan can indicate 2D positions or three-dimensional (3D) positions, depending of the scanning process utilized. In any case, in some embodiments, the point cloud is subsequently converted into a raster map after the scanning process, in particular a 2D raster map. The 2D raster map comprises a matrix or grid of pixels, in which each pixel indicates whether a corresponding 2D position in the floorplan (1) includes a physical obstruction, (2) does not include physical obstruction, or (3) is unexplored. Accordingly, references to a LiDAR scan in the description should be understood to refer interchangeably to a point cloud or to an equivalent a raster map. Likewise, references to points of a LiDAR scan or to pixels of a LiDAR scan in the description should be understood essentially interchangeably.

FIG. 1B shows an exemplary semantic map 50 generated based on the exemplary LiDAR scan 10 using a model developed according to systems and methods described herein. As used herein, a “semantic map” refers to a set of semantic labels associated with particular positions in a real or virtual environment. Thus, much like the LiDAR scan 10, the semantic map 50 may take the form of a point cloud or an equivalent raster map, in which semantic labels are associated with individual points or pixels. In the semantic map 50, the data of the LiDAR scan 10 has been annotated with semantic labels. The semantic labels may include a wide variety of classifications, estimations, and predictions of different aspects of the environment that was scanned by the LiDAR sensor.

In the illustrated embodiment, the semantic labels include labels for each explored point and/or pixel of the semantic map 50 that distinguish between the floor in the floorplan that was scanned (shown in solid white), walls in the floorplan (shown in solid black), and other obstructions detected on the floor (e.g., clutter or furniture, shown with grid cross-hatching). In at least some embodiments, the semantic labels include labels that identify obstructions detected on the floor at a class-level (e.g., “sofa,” “table,” “TV stand,” and “bed”), as well as at an instance-level (e.g., “Sofa 1,” “Sofa 2,” “Table 1,” and “Table 2”).

In some embodiments, the semantic labels include labels for each point and/or pixel of the semantic map 50 that segment the floorplan into different rooms. In the illustration of FIG. 1B, the room segmentation is identified only by room segmentation boundaries (e.g., shown as dashed lines between rooms), however in practice each point and/or pixel may be provided with a respective room label. In the illustrated embodiment, the room segmentation labels identify the rooms at a class-level (i.e., room type) and at an instance level (e.g., “Bedroom,” “Bathroom,” “Laundry Room,” “Hallway,” Kitchen,” “Living Room 1,” “Living Room 2,” “Dining Room 1,” and “Dining Room 2”). However, in some embodiments, room labels may only identify the rooms at an instance-level (e.g., “room 1,” “room 2,” “room 3,” etc.).

Finally, in at least some embodiments, the semantic labels include labels that identify points and/or pixels of the semantic map 50 that correspond to measurement errors caused by one of (i) glass and (ii) mirrors (shown with horizontal hatching). Particularly, it will be appreciated that materials such as glass and mirrors generally do not reflect light diffusely and instead reflect light in a specular manner. Accordingly, little to none of the measurement light emitted from the LiDAR sensor may be reflected directly back to the LiDAR sensor. As a result, the 2D LiDAR scan 10 may include erroneous points and/or pixels indicating an obstruction where there was no obstruction and erroneous points and/or pixels indicating the lack of obstruction. The 2D semantic map 50 advantageously includes semantic labels identifying the points and/or pixels at which these measurement errors may exist. Additionally, in some embodiments, the semantic labels further include labels that identify points and/or pixels of the semantic map 50 predicted to include the glass or mirror itself that caused these errors (not shown).

The systems and methods described herein are advantageous improvements to conventional techniques for several reasons. Firstly, semantic mapping models trained according the methods described herein take incomplete and noisy LiDAR scans as inputs, rather than requiring complete and clean floor plan drawings. Secondly, semantic mapping models trained according the methods described herein can detect mismeasurements caused by mirrors and glasses and further localize mirrors and glasses. Thirdly, semantic mapping models trained according the methods described herein can provide both instance-level fine-grained and class-level segmentation of the input LiDAR scans. Fourthly, the methods described herein provide a simulation pipeline that can be used to generate large-scale realistic training data, which greatly improves the performance of the trained semantic mapping models.

### Exemplary Model Development System

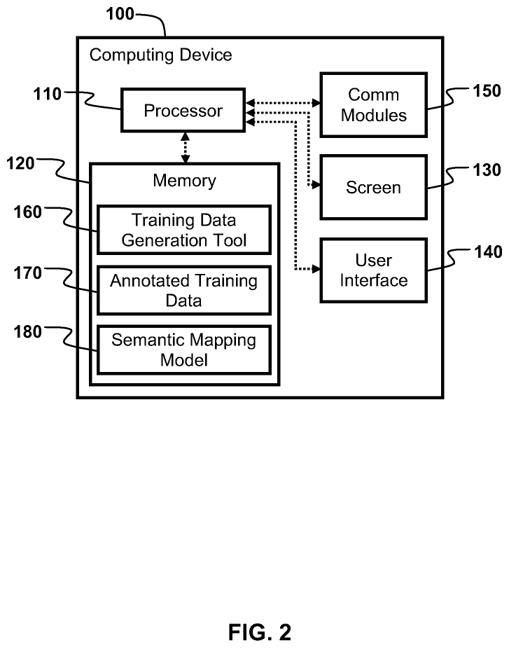

FIG. 2 shows an exemplary embodiment of a computing device 100 that can be used to develop and train a semantic mapping model that generates a richly annotated semantic map based on an input LiDAR scan. The computing device 100 comprises a processor 110, a memory 120, a display screen 130, a user interface 140, and at least one network communications module 150. It will be appreciated that the illustrated embodiment of the computing device 100 is only one exemplary embodiment is merely representative of any of various manners or configurations of a personal computer, laptop computer, tablet computer, smartphone, or any other computing devices that are operative in the manner set forth herein.

The processor 110 is configured to execute instructions to operate the computing device 100 to enable the features, functionality, characteristics and/or the like as described herein. To this end, the processor 110 is operably connected to the memory 120, the display screen 130, and the network communications module 150. The processor 110 generally comprises one or more processors which may operate in parallel or otherwise in concert with one another. It will be recognized by those of ordinary skill in the art that a “processor” includes any hardware system, hardware mechanism or hardware component that processes data, signals or other information. Accordingly, the processor 110 may include a system with a central processing unit, graphics processing units, multiple processing units, dedicated circuitry for achieving functionality, programmable logic, or other processing systems.

The memory 120 is configured to store data and program instructions that, when executed by the processor 110, enable the computing device 100 to perform various operations described herein. The memory 120 may be of any type of device capable of storing information accessible by the processor 110, such as a memory card, ROM, RAM, hard drives, discs, flash memory, or any of various other computer-readable medium serving as data storage devices, as will be recognized by those of ordinary skill in the art.

The display screen 130 may comprise any of various known types of displays, such as LCD or OLED screens. The user interface 140 may include a variety of interfaces for operating the computing device 100, such as a buttons, switches, a keyboard or other keypad, speakers, and a microphone. Alternatively, or in addition, the display screen 130 may comprise a touch screen configured to receive touch inputs from a user.

The network communications module 150 may comprise one or more transceivers, modems, processors, memories, oscillators, antennas, or other hardware conventionally included in a communications module to enable communications with various other devices. Particularly, the network communications module 150 generally includes a Wi-Fi module configured to enable communication with a Wi-Fi network and/or Wi-Fi router (not shown) configured to enable communication with various other devices. Additionally, the network communications module 150 may include a Bluetooth® module (not shown), as well as one or more cellular modems configured to communicate with wireless telephony networks.

The computing device 100 may also include a respective battery or other power source (not shown) configured to power the various components within the computing device 100. In one embodiment, the battery of the computing device 100 is a rechargeable battery configured to be charged when the computing device 100 is connected to a battery charger configured for use with the computing device 100.

In at least one embodiment, the memory 120 stores program instructions of a training data generation tool 160 configured to enable a user to generate richly annotated training data 170 for the purpose of training a semantic mapping model 180. As discussed in further detail below, the processor 110 is configured to execute program instructions of the training data generation tool 160 to enable the user to generate annotated training data, which generally takes the form of training data pairs consisting of input LiDAR scan data and corresponding output semantic maps, which are essentially similar to the exemplary LiDAR scan 10 of FIG. 1A and the exemplary semantic map 50 of FIG. 1B, respectively. The training data generation tool 160 advantageously enables generation of simulated LiDAR scans, which can supplement real LiDAR scans captured by real systems to provide a larger, more robust set of annotated training data 170. Finally, the semantic mapping model 180 can be trained using annotated training data 170, and deployed in the field on consumer devices, such as robot vacuum cleaners.

### Methods for Training a Semantic Mapping Model

A variety of methods and processes are described below for operating the computing device 100 to develop and train a semantic mapping model 180. In these descriptions, statements that a method, processor, and/or system is performing some task or function refers to a controller or processor (e.g., the processor 110 of the computing device 100) executing programmed instructions stored in non-transitory computer readable storage media (e.g., the memory 120 of the computing device 100) operatively connected to the controller or processor to manipulate data or to operate one or more components in the computing device 100 to perform the task or function. Additionally, the steps of the methods may be performed in any feasible chronological order, regardless of the order shown in the figures or the order in which the steps are described.

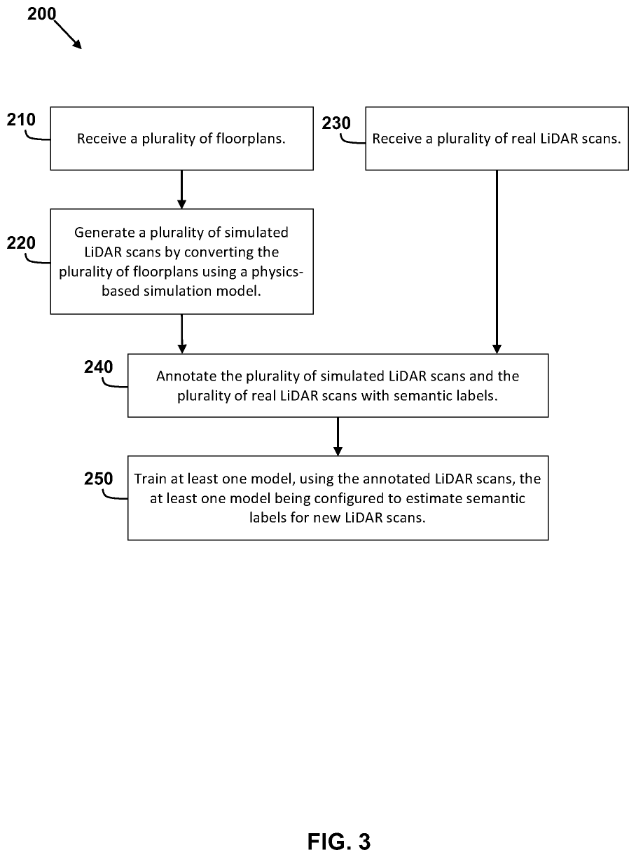

FIG. 3 shows a method 200 for developing a semantic mapping model that generates a richly annotated semantic map based on an input LiDAR scan. The method 200 advantageously utilizes a physics-based simulation model to generate realistic simulated LiDAR scans based on 2D floorplans. Additionally, the method 200 advantageously enables automated annotation of simulated LiDAR scans and simplified annotation of real LiDAR scans. Furthermore, the due to the simulation and annotation of measurement errors caused by glass or mirrors, the resulting trained semantic mapping model is capable of detecting such measurement errors caused by glass or mirrors. Finally, the method 200 advantageously incorporates a discriminator mechanism during training of the semantic mapping model to bridge the domain gap between the simulated LiDAR scans and the real LiDAR scans in the training data.

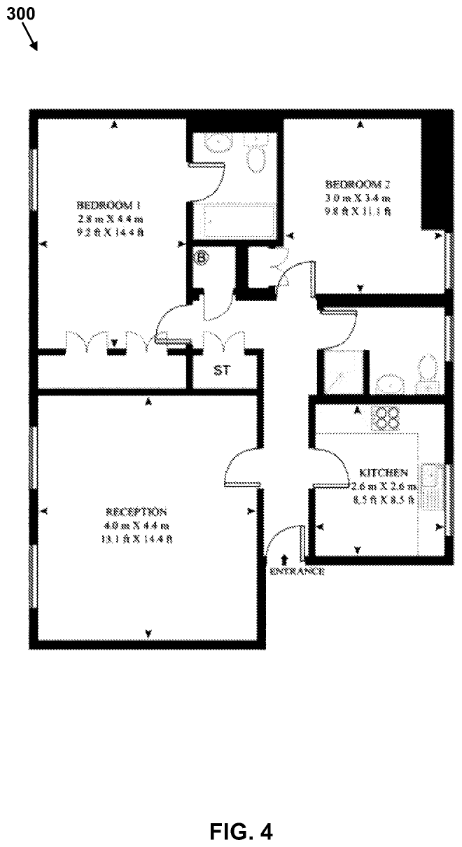

The method 200 begins with receiving a plurality of floorplans (block 210). Particularly, the processor 110 receives, and stores in the memory 120, a plurality of floorplans. In at least one embodiment, these floorplans are 2D floorplans. However, in other embodiments, 3D floorplans can be utilized. In some embodiments, these floorplans can be obtained from a public dataset or can be generated, such as by a generative adversarial network (GAN)-based method. The plurality of floorplans can be received or generated in a variety of formats, such as a raster image or vector image, or any of a variety of 3D model or 2D model file formats. FIG. 4 shows an exemplary 2D floorplan 300. The 2D floorplan 300 has several rooms including a kitchen, a reception area, two bedrooms, and two bathrooms. The room boundaries are defined by thick black lines.

In some embodiments, the processor 110 receives user inputs from a user via the user interface 140 for the purpose of manually pre-processing or labeling the floorplans. In one embodiment, the processor 110 receives user inputs from a user via the user interface 140 defining a scaling factor for each respective floorplan. In one embodiment, the processor 110 receives user inputs from a user via the user interface 140 defining polygon-level annotations, such as polygons defining room boundaries or fixture boundaries (e.g., cabinetry, sinks, bath tubs, or the like). In some embodiments, the processor 110 performs certain automated pre-processing of the plurality of floorplans, such as converting the format of the floorplans into a stand format (e.g., converting raster images into vector images), using suitable processes.

The method 200 continues with generating a plurality of simulated LiDAR scans by converting the plurality of floorplans using a physics-based simulation model (block 220). Particularly, the processor 110 generates, and stores in the memory 120, a plurality of simulated LiDAR scans based on the plurality of floorplans. In each case, the processor 110 generates the simulated LiDAR scan based on a respective floorplan using a physics-based simulation model.

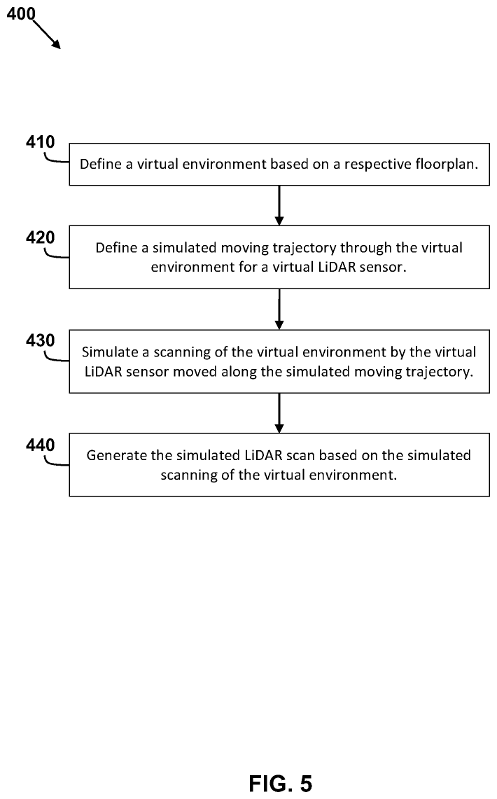

FIG. 5 shows an exemplary method 400 for generating a simulated LiDAR scan based on a floorplan. The method 400 begins with defining a virtual environment based on a respective floorplan (block 410). Particularly, the processor 110 defines a virtual environment having floors and walls placed in accordance with a respective floorplan. In some embodiments, the processor 110 defines the virtual environment to further include various fixtures, such as cabinetry, sinks, bath tubs, or the like, which are defined in the respective floorplan. In some embodiments, the processor 110 defines the virtual environment to further include other virtual objects such as furniture (e.g., sofas, tables, beds) arranged on the floor, as discussed in greater detail below. Some of these virtual objects may include glass or mirrors. In at least some embodiments, the processor 110 defines material properties for each virtual structure (i.e., walls, fixtures, furniture, etc.) in the virtual environment, at least including reflective characteristics of the structures.

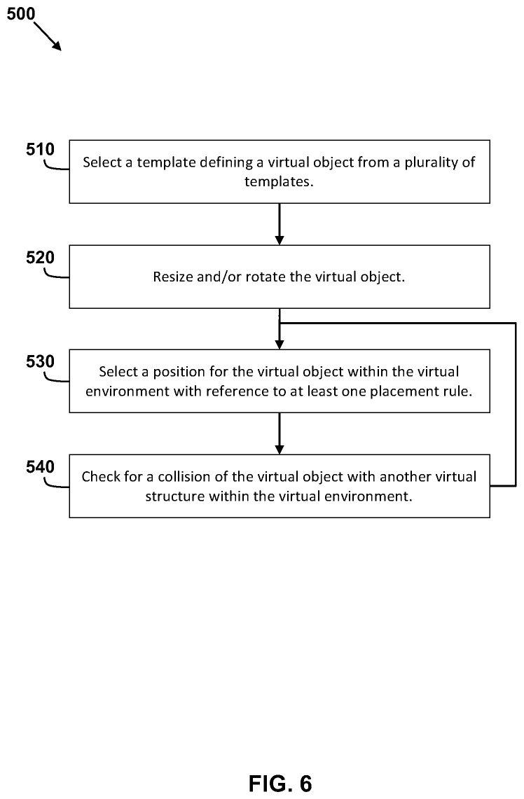

FIG. 6 shows an exemplary method 500 for placing virtual objects into the virtual environment. The method 500 begins with selecting a template defining a virtual object from a plurality of templates (block 510). Particularly, the processor 110 selects a template from a plurality of templates that each define a respective virtual object, such as furniture, including some furniture incorporating mirrors/glass, as well as various sorts of clutter objects (e.g., children's toys, etc.). Each template defines a shape and size of a respective virtual object, as well as the material properties of the respective virtual object.

The method 500 continues with resizing and/or rotating the virtual object (block 520). Particularly, the processor 110 resizes and/or rotates the virtual object that is defined by the selected template. More particularly, in some embodiments, the processor 110 resizes the virtual object to match a scale of the selected floorplan or, optionally, with a random scaling within a reasonable predefined range relative to the scale of the selected floorplan. Additionally, the processor 110 rotates the orientation of virtual object randomly or according to predetermined rules for the virtual object (e.g., certain virtual objects might only be oriented in certain ways).

The method 500 continues with selecting a position for the virtual object within the virtual environment with reference to at least one placement rule (block 530). Particularly, the processor 110 selects a position for the virtual object within the virtual environment. The position for the virtual object within the virtual environment is selected depending on or constrained by one or more placement rules, which may depend on a type of object defined by the template. For example, certain virtual object types might only be placed in particular room types (e.g., a bed can only be placed in a bedroom or a bathtub can only be placed in a bathroom). As another example, certain virtual objects might only be placed a certain distance from a wall (e.g., a table), while certain other virtual objects might only be placed on a wall or directly touching (e.g., a wall mirror).

The method 500 continues with checking for a collision of the virtual object with another virtual structure within the virtual environment (block 540). Particularly, the processor 110 checks for a collision (i.e., an intersection) of the virtual object with another virtual structure (i.e., walls, fixtures, furniture, other objects, etc.) when placed at the selected position. In response to detecting a collision of the virtual object, the processor 110 selects another position within the virtual environment to place the virtual object (i.e., the method 500 returns to block 530). Otherwise, the processor 110 moves on to placing the next virtual object or finishing with the placing of virtual objects.

Returning to FIG. 5, the method 400 continues with defining a simulated moving trajectory through the virtual environment for a virtual LiDAR sensor (block 420). Particularly, the processor 110 determines, either randomly or procedurally, a simulated moving trajectory through the virtual environment. The simulated moving trajectory is a path or time-sequence of positions within the virtual environment along which a virtual LiDAR sensor will be moved through the virtual environment to simulate a scanning process of the virtual environment by the virtual LiDAR sensor.

The method 400 continues with simulating a scanning of the virtual environment by the virtual LiDAR sensor moved along the simulated moving trajectory (block 430). Particularly, the processor 110 simulates a scanning of the virtual environment by moving the virtual LiDAR sensor along the simulated moving trajectory. At each respective position of a plurality of positions along the simulated moving trajectory, the processor 110 simulates the emission of measurement light from the virtual LiDAR sensor at the respective position, the reflection of the measurement light through the virtual environment, and reception of the measurement light at the virtual LiDAR sensor at the respective position, using a physics based-model. In simulating the emission, reflection, and reception of the measurement light, the processor 110 takes into consideration the virtual structures in the virtual environment (i.e., walls, fixtures, furniture, etc.) and their material properties, in particular their reflective characteristics. In this way, virtual glass or mirrors having specular reflective characteristics will give rise to realistic measurement errors.

In at least one embodiment, the processor 110 simulates the emission, reflection, and reception of the measurement light using a raytracing-based simulation model. The material properties of the virtual structures are modeled by laser/light intensity response curves (i.e., intensity vs. incident angle). Additionally, the processor 110 utilizes a LiDAR sensor model which models range, accuracy, and precision (e.g., which can be modeled by step functions or splines), as well as angular resolution, Lambertian reflectivity, detection probability, and beam divergence. In one embodiment, a signal attenuation in the raytracing-based simulation model is adjustable and may, for example, be set to

$$\frac{1}{{R}^{2}} or \frac{1}{{R}^{3}} .$$

In one embodiment, a maximum recursion depth for the raytracing-based simulation model can be adjusted.

The method 400 continues with generating the simulated LiDAR scan based on the simulated scanning of the virtual environment (block 440). Particularly, based on the simulated scanning of the virtual environment, the processor 110 generates a simulated LiDAR scan of the respective floorplan. In particular, the processor 110 calculates simulated times of flight and/or simulated return times for the measurement light (i.e., a time between emission and reception of the measurement light). Based on the simulated times of flight and/or simulated return times, the processor 110 generates the simulated LiDAR scan, for example in the form of a point cloud or raster map, as discussed above with respect to the exemplary LiDAR scan 10. In at least one embodiment, the processor 110 applies sensor noise to the simulated LiDAR scan, or more particularly, to the simulated times of flight and/or simulated return times. In this way, the processor 110 generates a more realistic simulated LiDAR scan.

Returning to FIG. 3, the method 200 continues with receiving a plurality of real LiDAR scans (block 230). Particularly, the processor 110 receives, and stores in the memory 120, a plurality of real LiDAR scans that were measured by real LiDAR sensors. The plurality of real LiDAR scans may, for example, have been measured by end-user devices deployed in the field, such as robot vacuum cleaners. Alternatively, or in addition, the plurality of real LiDAR scans may include LiDAR scans that were simply collected solely for this purpose or obtained from a public dataset.

The method 200 continues with annotating the plurality of simulated LiDAR scans and the plurality of real LiDAR scans with semantic labels (block 240). Particularly, the processor 110 annotates the plurality of simulated LiDAR scans and the plurality of real LiDAR scans by generating semantic labels for each respective LiDAR scan and compiling them into respective semantic map for each respective LiDAR scan. In some embodiments, the processor 110 automatically generates at least some of the semantic labels for each simulated LiDAR scan based, in part, the virtual environment that was defined based on the respective floorplan. In some embodiments, the processor 110 automatically generates at least some of the semantic labels for each real LiDAR scan based on the measurements of the respective real LiDAR scan. In some embodiments, the processor 110 generates at least some of the semantic labels for each real LiDAR scan based on manual user inputs received via a user interface.

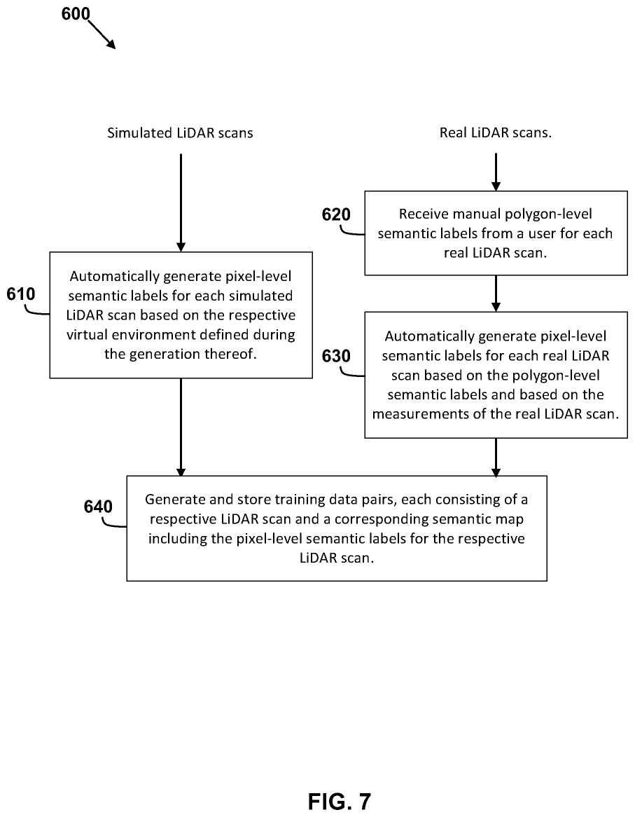

FIG. 7 shows an exemplary method 600 for annotating simulated LiDAR scans and real LiDAR scans with semantic labels. The method 600 begins with automatically generating pixel-level semantic labels for each simulated LiDAR scan based on the respective virtual environment defined during the generation thereof (block 610). Particularly, for each respective pixel in each respective simulated LiDAR scan, the processor 110 checks a corresponding position in the virtual environment from which the simulated LiDAR scan was generated and labels the respective pixel with the appropriate semantic labels based on the virtual structures, room type/instance, and other features at the position in the virtual environment.

In some embodiments, the processor 110 generates semantic labels that distinguish between unexplored regions, walls, floors, and other obstructions detected on the floors (e.g., furniture or clutter). Particularly, if a pixel that is unexplored coincides with a position that is outside of the virtual environment or within a virtual structure of the virtual environment, then the processor 110 labels the respective pixel with a “unexplored” semantic label. Additionally, if a pixel at which no obstruction was detected (i.e., white pixels) coincides with the floor of the virtual environment, then the processor 110 labels the respective pixel with a “floor” semantic label. Conversely, if a pixel at which an obstruction was detected (i.e., black pixels) coincides with a virtual wall of the virtual environment, then the processor 110 labels the respective pixel with a “wall” semantic label. Similarly, if a pixel at which an obstruction was detected (i.e., black pixels) coincides with a virtual furniture object or virtual clutter object in the virtual environment, then the processor 110 labels the respective pixel with a “furniture/clutter” semantic label. In at least some embodiments, the semantic labels include labels that identify virtual furniture objects or virtual clutter objects detected on the floor at a class-level (e.g., “sofa,” “table,” “TV stand,” and “bed”), as well as at an instance-level (e.g., “Sofa 1,” “Sofa 2,” “Table 1,” and “Table 2”).

Additionally, in some embodiments, the processor 110 generates semantic labels that identify a room type and room instance. Particularly, the processor 110 generates room labels for each pixel based on the room of the virtual environment corresponding to the position of the respective pixel. In at least some embodiments, the room segmentation labels identify the rooms at a class-level (i.e., room type) and at an instance level (e.g., “Bedroom,” “Bathroom,” “Laundry Room,” “Hallway,” Kitchen,” “Living Room 1,” “Living Room 2,” “Dining Room 1,” and “Dining Room 2”). However, in some embodiments, room labels may only identify the rooms at an instance-level (e.g., “room 1,” “room 2,” “room 3,” etc.).

In some embodiments, the processor 110 further generates semantic labels that identify measurement errors, such as those errors typically caused by glass or mirrors. Particularly, if a pixel at which no obstruction was detected (i.e., white pixels) coincides with a position that is outside of the virtual environment or within a virtual structure of the virtual environment, then the processor 110 labels the respective pixel with a “mirror/glass error” semantic label. Likewise, if a pixel at which an obstruction was detected (i.e., black pixels) coincides with a position that is outside of the virtual environment or within a virtual structure of the virtual environment, then the processor 110 labels the respective pixel with a “mirror/glass error” semantic label.

In some embodiments, the processor 110 further generates semantic labels that identify virtual structures containing mirrors or glass. Particularly, if a pixel coincides with a virtual furniture object or virtual clutter object in the virtual environment having material properties of glass or a mirror, then the processor 110 labels the respective pixel with a “mirror/glass” semantic label identifying that mirror or glass is located at that pixel.

With continued reference to FIG. 7, the method 600 continues with receiving manual polygon-level semantic labels from a user for each real LiDAR scan (block 620). Particularly, for at least some of the real LiDAR scans, the processor 110 receives user inputs from a user via the user interface 140 defining at least one polygon in the space of the real LiDAR scan that indicate semantic labels for pixels bounded within the polygon. For example, some of the polygons might be provided to identify furniture or other clutter that was detected in a real LiDAR scan. As another example, some of the polygons might be provided to identify individual room instances or room types. As a further example, some of the polygons might be provided to identify measurement errors in the respective real LiDAR scan, such as those errors typically caused by glass or mirrors. As a final example, some of the polygons might be provided to identify furniture or other objects having mirrors or glass that caused measurement errors.

The method 600 continues with automatically generating pixel-level semantic labels for each real LiDAR scan based on the polygon-level semantic labels and based on the measurements of the real LiDAR scan (block 630). Particularly, for each respective pixel in each respective simulated LiDAR scan, the processor 110 determines one or more semantic labels. The processor 110 determines pixel-level semantic labels based on the measurements from the real LiDAR scans and based on the polygon-level semantic labels.

Particularly, the processor 110 labels each pixel that is unexplored with the “unexplored” semantic label. Additionally, the processor 110 labels each pixel at which no obstruction was detected (i.e., white pixels) with the “floor” semantic label if the pixel is not bounded by a polygon identifying measurement errors or identifying furniture or other objects having mirrors or glass that caused measurement errors. Furthermore, the processor 110 labels each pixel at which an obstruction was detected (i.e., black pixels) with the “wall” semantic label if the pixel is not bounded by a polygon identifying furniture or other clutter. Conversely, the processor 110 labels each pixel at which an obstruction was detected (i.e., black pixels) with the “furniture/clutter” semantic label if the pixel is also bounded by a polygon indicated furniture or other clutter. In at least some embodiments, the semantic labels associated with the polygons identify virtual furniture objects or virtual clutter objects detected on the floor at a class-level (e.g., “sofa,” “table,” “TV stand,” and “bed”), as well as at an instance-level (e.g., “Sofa 1,” “Sofa 2,” “Table 1,” and “Table 2”).

Additionally, in some embodiments, the processor 110 labels each pixel with semantic labels that identify a room type and/or room instance if they are bounded by a polygon that specifies a room type and/or room instance. In at least some embodiments, the semantic labels associated with the polygons identify the rooms at a class-level (i.e., room type) and at an instance level (e.g., “Bedroom,” “Bathroom,” “Laundry Room,” “Hallway,” Kitchen,” “Living Room 1,” “Living Room 2,” “Dining Room 1,” and “Dining Room 2”). However, in some embodiments, the semantic labels associated with the polygons may only identify the rooms at an instance-level (e.g., “room 1,” “room 2,” “room 3,” etc.).

Moreover, in some embodiments, the processor 110 labels pixels with the “mirror/glass error” semantic label if they are bounded by a polygon that identifies those measurement errors in the real LiDAR scan. Likewise, the processor 110 labels each pixel with the “mirror/glass” semantic label if they are bounded by a polygon that identifies furniture or other objects having mirrors or glass.

With continued reference to FIG. 7, the method 600 continues with generating and storing training data pairs, each consisting of a respective LiDAR scan and a corresponding semantic map including the pixel-level semantic labels for the respective LiDAR scan (block 640). Particularly, for each respective LiDAR scan, the processor 110 generates a respective semantic map for the respective LiDAR scan by compiling the pixel-level semantic labels for the respective LiDAR scan (e.g., in a form similar to the exemplary semantic map 50 of FIG. 1B). In each case, the processor 110 stores the respective semantic map in the memory 120 in association with the respective LiDAR scan, thereby forming a training data pair that can be used for training the semantic mapping model 180. These training data pairs collectively comprise the annotated training data 170.

Returning to FIG. 3, the method 200 continues with training at least one model, using the annotated LiDAR scans, the at least one model being configured to estimate semantic labels for new LiDAR scans (block 250). Particularly, the processor 110 trains the semantic mapping model 180 based on the annotated training data 170, which includes a plurality of training data pairs each consisting of a respective LiDAR scan and a corresponding semantic map. Once trained, the semantic mapping model 180 is configured to estimate a semantic map for new LiDAR scans, in particular new real LiDAR scans.

The semantic mapping model 180 may comprise any type or combination of traditional or deep-learning based models configured to perform semantic segmentation, panoptic segmentation, floor plan recognition, etc. The semantic mapping model 180 may, for example comprise one or more machine learning models such as convolution neural networks, or the like. As used herein, the term “machine learning model” refers to a system or set of program instructions and/or data configured to implement an algorithm, process, or mathematical model (e.g., a neural network) that predicts or otherwise provides a desired output based on a given input. It will be appreciated that, in general, many or most parameters of a machine learning model are not explicitly programmed and the machine learning model is not, in the traditional sense, explicitly designed to follow particular rules in order to provide the desired output for a given input. Instead, a machine learning model is provided with a corpus of training data from which it identifies or “learns” implicit patterns and statistical relationships in the data, which are generalized to make predictions or otherwise provide outputs with respect to new data inputs. The result of the training process is embodied in a plurality of learned parameters, kernel weights, and/or filter values that are used in the various components of the machine learning model to perform various operations or functions.

It should, at this point, be appreciated that the annotated training data 170 comprises two categories of training data pairs: (1) simulated training data pairs consisting of a respective simulated LiDAR scan and a corresponding semantic map, and (2) real training data pairs consisting of a respective real LiDAR scan and a corresponding semantic map.

Generally, the semantic mapping model 180 will achieve the best performance when trained with a large number of real training data pairs. Accordingly, if the number of available real training data pairs reaches a sufficient threshold amount of training data, then the semantic mapping model 180 could be trained only using the real training data pairs. However, in practice, it is very time-consuming to collect and annotate a sufficiently large number of real LiDAR scans so as to cover all the possible corner cases. Therefore, in most embodiments, the semantic mapping model 180 must be trained using a combination of the simulated training data pairs and the real training data pairs.

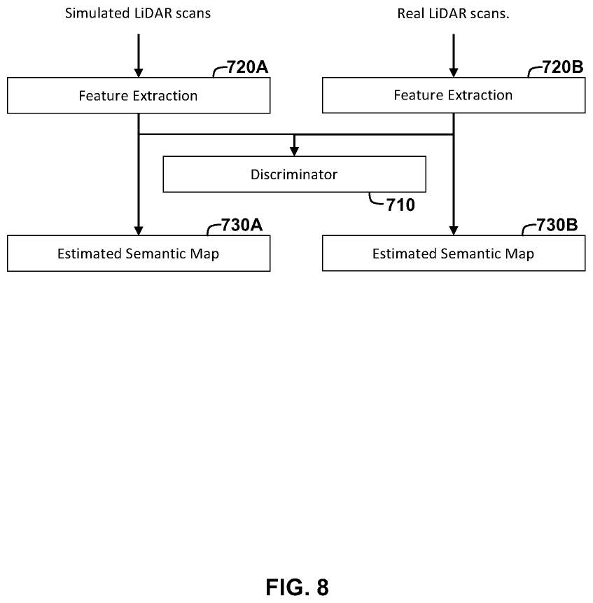

In at least some embodiments, a domain adaptation approach is utilized during the training process to bridge the gap between the simulated training data and the real training data. FIG. 8 shows an exemplary domain adaptation approach for training the semantic mapping model 180. Particularly, for each pair of simulated and real LiDAR scans, a discriminator 710 is applied after respective feature extractors 720A and 720B. During training, the feature extractor 720A is trained to extract features from simulated LiDAR scans, the feature extractor 720B is trained to extract features from real LiDAR scans, and the discriminator 710 is trained to distinguish between the features extracted from the simulated LiDAR scans and the features extracted from the real LiDAR scans. The output of the discriminator 710 be either 0 or 1 indicating which domain the extracted features are from.

In some embodiments, during training, learned parameters and/or weights of the feature extractors 720A and 720B are fine-tuned based both on (i) a classification loss depending on semantic labeling errors in the estimated semantic maps 730A, 730B and (ii) a discrimination loss depending on domain discrimination errors by the discriminator 710. In particular, the feature extractors 720A and 720B are fine-tuned to minimize classification errors in the estimated semantic maps and to minimize the ability of the discriminate between real and simulated LiDAR scans. Similarly, during training, the learned parameters and/or weights of the discriminator 710 are fine-tuned based on the discrimination loss depending on domain discrimination errors by the discriminator 710.

In some embodiments, the both feature extractors 720A and 720B are trained simultaneously. Moreover, in some embodiments, the both feature extractors 720A and 720B are the same neural network and share the same learned parameters and/or weights. Alternatively, in some embodiments, the feature extractor 720A (i.e., the source feature extractor) is pre-trained, prior to domain adaptation, using conventional methods depending only on a classification loss using the generally larger collection of simulated training data. Next, the feature extractor 720B (i.e., the target feature extractor) is trained depending on discrimination loss and classification loss, using the generally smaller collection of real training data. In any case, it should be appreciated that the semantic mapping model 180 that is deployed on end-user devices incorporates the feature extractor 720B (i.e., the target feature extractor) for feature extraction.

In some embodiments, this domain adaptation and/or training is an iterative process. For example, during some phases of the training, the parameters and/or weights of the feature extractors 720A and 720B are fine-tuned, while the parameters and/or weights of the discriminator 710 are fixed. Conversely, during other phases of the training, the parameters and/or weights of the discriminator 710 are fine-tuned, while the feature extractors 720A and 720B are fixed. Popular implementations of this iterative process could include GAN-based deep neural networks and expectation maximization (EM)—like methods.

### Exemplary End-User Device

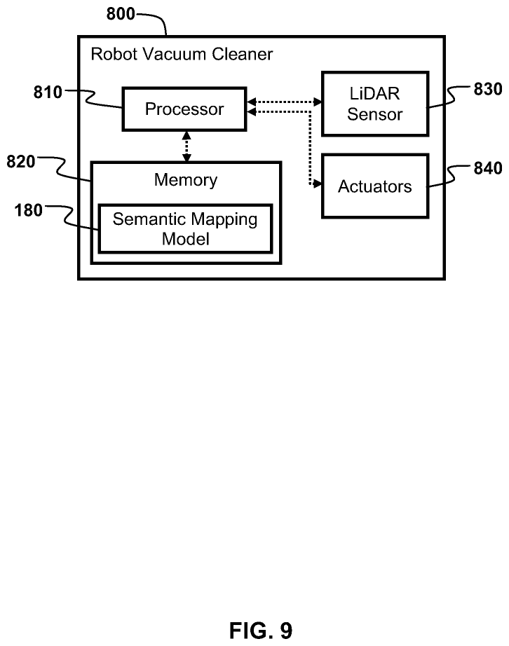

FIG. 9 shows an exemplary end-user device in the form of a robot vacuum cleaner 800 that incorporates the trained semantic mapping model 180. The robot vacuum cleaner 800 comprises a processor 810, a memory 820, a LiDAR sensor 830, and one or more actuators 840. It will be appreciated that the illustrated embodiment of the robot vacuum cleaner 800 is only one exemplary embodiment is merely representative of any of various manners or configurations of end-user devices, including various other similar devices that must interpret LiDAR scans of an environment to perform a task.

The processor 810 is configured to execute instructions to operate the robot vacuum cleaner 800 to enable the features, functionality, characteristics and/or the like as described herein. To this end, the processor 110 is operably connected to the memory 820, the LiDAR sensor 830, and the one or more actuators 840. The processor 810 generally comprises one or more processors which may operate in parallel or otherwise in concert with one another. It will be recognized by those of ordinary skill in the art that a “processor” includes any hardware system, hardware mechanism or hardware component that processes data, signals or other information. Accordingly, the processor 810 may include a system with a central processing unit, graphics processing units, multiple processing units, dedicated circuitry for achieving functionality, programmable logic, or other processing systems.

The memory 820 is configured to store data and program instructions that, when executed by the processor 810, enable the robot vacuum cleaner 800 to perform various operations described herein. The memory 820 may be of any type of device capable of storing information accessible by the processor 810, such as a memory card, ROM, RAM, hard drives, discs, flash memory, or any of various other computer-readable medium serving as data storage devices, as will be recognized by those of ordinary skill in the art. In at least one embodiment, the memory 820 stores the trained semantic mapping model 180. As discussed in further detail below, the processor 810 is configured to execute program instructions of the trained semantic mapping model 180 to estimate a semantic map based on a real LiDAR scan captured using the LiDAR sensor 830.

The LiDAR sensor 830 is configured to emit measurement light (e.g., lasers) and receive the measurement light after it has reflected throughout the environment. The processor 810 is configured to calculate times of flight and/or return times for the measurement light. Based on the calculated times of flight and/or return times, the processor 810 generates a real LiDAR scan, for example in the form of a point cloud or raster map.

The one or more actuators 840 at least include motors of a locomotion system that, for example, drive a set of wheels to cause the robot vacuum cleaner 800 to move throughout the environment during the LiDAR scanning process, as well as during a vacuuming operation. Additionally, the one or more actuators 840 at least include a vacuum suction system configured to vacuum environment as the robot vacuum cleaner 800 is moved throughout the environment.

The robot vacuum cleaner 800 may also include a respective battery or other power source (not shown) configured to power the various components within the robot vacuum cleaner 800. In one embodiment, the battery of the robot vacuum cleaner 800 is a rechargeable battery configured to be charged when the robot vacuum cleaner 800 is connected to a battery charger configured for use with the robot vacuum cleaner 800.

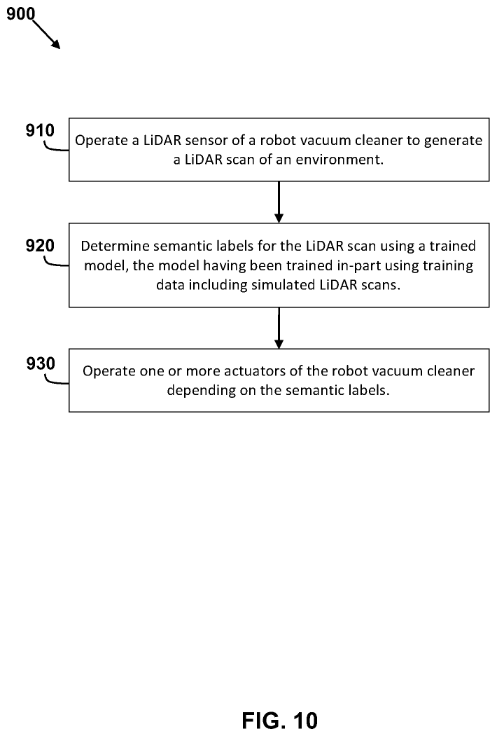

FIG. 10 shows a method 900 for operating the robot vacuum cleaner 800 using the trained semantic mapping model 180. The method 900 begins with operating a LiDAR sensor of a robot vacuum cleaner to generate a LiDAR scan of an environment (block 910). Particularly, the processor 810 operates the LiDAR sensor 830 to emit measurement light and receive the measurement light after it has reflected throughout an environment (e.g., a residential home). Next, the processor 810 calculates times of flight and/or return times for the measurement light. Finally, based on the calculated times of flight and/or return times, the processor 810 generates a real LiDAR scan of the environment, for example in the form of a point cloud or raster map. This process may, for example, occur in a learning phase that is initiated by the end-user.

The method 900 continues with determining semantic labels for the LiDAR scan using a trained model, the model having been trained in-part using training data including simulated LiDAR scans (block 920). Particularly, the processor 810 executes program instructions of the trained semantic mapping model 180 to estimate a semantic map for the environment based on the real LiDAR scan of the environment generated using the LiDAR sensor 830. This process may, for example, occur in after or at the end of the learning phase that was initiated by the end-user.

In at least one embodiment, the processor 810 uses the trained semantic mapping model 180 to identify portions of the real LiDAR scan that correspond to a floor in the environment. In at least one embodiment, the processor 810 uses the trained semantic mapping model 180 to identify portions of the real LiDAR scan that correspond to a wall in the environment. In at least one embodiment, the processor 810 uses the trained semantic mapping model 180 to identify portions of the real LiDAR scan that correspond to an obstruction detected on the floor in the environment. In at least one embodiment, the processor 810 uses the trained semantic mapping model 180 to identify portions of the real LiDAR scan that correspond to unexplored regions of the environment.

In at least one embodiment, the processor 810 uses the trained semantic mapping model 180 to identify portions of the real LiDAR scan that correspond to particular room types in the environment. In at least one embodiment, the processor 810 uses the trained semantic mapping model 180 to identify portions of the real LiDAR scan that correspond to particular room instances in the environment.

In at least one embodiment, the processor 810 uses the trained semantic mapping model 180 to identify portions of the real LiDAR scan that correspond to measurement errors caused by glass and/or mirrors. In at least one embodiment, the processor 810 uses the trained semantic mapping model 180 to identify portions of the LiDAR scan that correspond to the glass and/or mirrors the caused the aforementioned measurement errors. In one embodiment, the processor 810 modifies the real LiDAR scan to correct the measurement errors caused by glass and/or mirrors.

The method 900 continues with operating one or more actuators of the robot vacuum cleaner depending on the semantic labels (block 930). Particularly, the processor 810 operates one or more of the actuators 840, such as motors of the locomotion system and/or the vacuum suction system, depending on the semantic labels of the generated semantic map for the environment. In one example, the processor 810 operates the motors of the locomotion system to efficiently navigate the environment depending on the semantic labels indicating the locations of walls, floors, furniture, mirrors, glass, clutter, and/or measurement errors. In another example, the processor 810 operates one or more of the actuators 840 to vacuum clean a particular room instance or room type depending on the semantic labels identifying the particular room instances or room types. These processes may, for example, occur during an operating phase that occurs after the learning phase and which was initiated by the end-user or automatically initiated based on a user-defined schedule.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for training a model to estimate semantic labels for LiDAR scans, the method comprising:
receiving, with a processor, a floorplan;
generating, with the processor, a simulated LiDAR scan by converting the floorplan using a physics-based simulation model;
annotating, with the processor, the simulated LiDAR scan with semantic labels; and
training, with the processor, the model using the simulated LiDAR scan.

2. The method according to claim 1, the generating the simulated LiDAR scan further comprising:
defining a virtual environment based on the floorplan;
determining a simulated moving trajectory through the virtual environment;
simulating a scanning of the virtual environment by a LiDAR sensor that is moved along the simulated moving trajectory; and
generating the simulated LiDAR scan based on the simulated scanning of the virtual environment.

3. The method according to claim 2, the simulating the scan of the virtual environment further comprising:
simulating the scanning of the virtual environment using raytracing-based techniques.

4. The method according to claim 2, the generating the simulated LiDAR scan further comprising:
applying sensor noise to the simulated scan.

5. The method according to claim 2, the generating the simulated LiDAR scan further comprising:
adding virtual objects to the virtual environment before the simulating the scanning of the virtual environment.

6. The method according to claim 5, the adding virtual objects to the virtual environment further comprising:
selecting a position of the virtual object within the virtual environment,
wherein the simulating the scanning of the virtual environment takes into account the virtual object located at the selected position within the virtual environment.

7. The method according to claim 6, the adding virtual objects to the virtual environment further comprising:
selecting a template for the virtual object from a plurality of templates, each template in the plurality of templates defining a type, a shape, and a size of a respective virtual object; and
selecting the position depending on a type of the virtual object that is defined by the selected template.

8. The method according to claim 6, the selecting the position of the virtual object further comprising:
checking for a collision of the virtual object with another structure within the virtual environment.

9. The method according to claim 6, wherein:
the virtual object includes at least one of a mirror and glass; and
the simulating the scanning of the virtual environment takes into account measurement errors that would be caused by the at least one of the mirror and the glass.

10. The method according to claim 2, the annotating the simulated LiDAR scan further comprising:
automatically generating the semantic labels based on the defined virtual environment.

11. The method according to claim 1, wherein the semantic labels include (i) a label identifying floors in the environment, (ii) a label identifying walls in the environment, and (iii) at least one label identifying obstructions detected on the floor.

12. The method according to claim 1, wherein the semantic labels include at least one of (i) a label identifying a room type of a portion of the environment and (ii) a label identifying a room instance of a portion of the environment.

13. The method according to claim 1, wherein the semantic labels include at least one of (i) a label identifying measurement errors caused by one of a mirror and glass, and (ii) a label identifying a location of one of a mirror and glass in the environment.

14. The method according to claim 1 further comprising:
receiving, with the processor, a real LiDAR scan that was measured by a real LiDAR sensor;
annotating, with the processor, the real LiDAR with the semantic labels; and
training, with the processor, the model using the simulated LiDAR scan and the real LiDAR.

15. The method according to claim 14, the annotating the real LiDAR scan further comprising:
receiving, via a user interface, user inputs defining at least one polygon in the real LiDAR scan; and
automatically generating the semantic labels based (i) measurements of the real LiDAR scan and (ii) the at least one polygon.

16. The method according to claim 14, the training the model further comprising:
training a discriminator to distinguish between features extracted from simulated LiDAR scans and features extracted from real LiDAR scans; and
training a feature extractor of the model to extract features from LiDAR scans using the discriminator.

17. A method for operating a device, the method comprising:
capturing, with a LiDAR sensor of the device, a LiDAR scan of an environment;
generating, with a processor of the device, semantic labels for the LiDAR scan using a trained model, the model having been trained in-part using simulated LiDAR scans, the generating semantic labels comprising:
identifying portions of the LiDAR scan that correspond to a floor in the environment; and
identifying portions of the LiDAR scan that correspond to a wall in the environment; and
operating at least one actuator of the device to perform a task depending on the semantic labels for the LiDAR scan.

18. The method according to claim 17, the generating semantic labels further comprising:
identifying portions of the LiDAR scan that correspond to an obstruction detected on the floor in the environment.

19. The method according to claim 17, the generating semantic labels further comprising at least one of:
identifying portions of the LiDAR scan that correspond to particular room types in the environment; and
identifying portions of the LiDAR scan that correspond to particular room instances in the environment.

20. The method according to claim 17, the generating semantic labels further comprising at least one of:
identifying portions of the LiDAR scan that correspond to measurement errors caused by one of (i) glass and (ii) mirrors; and
identifying portions of the LiDAR scan that correspond to one of (i) glass and (ii) mirrors.
